(19) United States
(12) Patent Application Publication
(10) Pub. No.: US 2026/0357886 A1
(43) Pub. Date: Nov. 12, 2026

(54) FLUID DELIVERY DEVICE FOR TRANSFERRING A LUBRICANT

(71) Applicant: FLENDER GMBH, 46395 Bocholt (DE)

(72) Inventors: Michael Nafe, Bocholt (DE); JULIAN THELING, Bocholt (DE)

(73) Assignee: FLENDER GMBH, 46395 Bocholt (DE)

(21) Appl. No.: 19/491,209

(22) PCT Filed: Jul. 8, 2024
(86) PCT No.: PCT/EP2024/069178

§ 371 Date: Dec. 8, 2025

(30) Foreign Application Priority Data
Jul. 11, 2023 (EP) 23184628.8

(51) Int. Cl. F16H 57/04; F03D 15/10; F03D 80/70

(52) U.S. Cl. CPC F16H 57/0479; F03D 15/10; F03D 80/701; F16H 57/0423; F16H 57/043; F16H 57/0471; F16H 57/0486; F05B 2260/40311; F05B 2260/98

(57) ABSTRACT

A fluid transfer device for transferring a lubricant, in particular within a wind turbine gearbox for an industrial wind turbine, includes a first component, a second component rotatable relative to the first component, an annular chamber formed on an end face of the first component facing the second component for receiving the lubricant, at least one hollow pin connected to the second component and extending axially into the annular chamber for fluidic communication between the annular chamber and a fluid channel of the second component, and a cover connected to the first component and designed to captively retain the hollow pin in the annular chamber. The cover forms a first plain bearing surface, with the hollow pin axially supported on the first plain bearing surface via a second plain bearing surface.

The invention relates to a fluid transfer device with the aid of which a lubricant, in particular within a wind turbine gearbox for an industrial wind turbine, can be transferred between components that are rotatable relative to each other.

From WO 2006/053940 A1 it is known to use a prestressed flange to form an annular chamber filled with a lubricant, wherein the prestressed flange presses against a plain bearing surface in which openings of fluid channels are formed in the radius region of the annular chamber, such that an axial transfer of lubricant from the annular chamber into the fluid channels can take place within a planetary transmission.

US 2007/0049448 A1 discloses a fluid transfer device which is formed in a planetary transmission and in which a planet carrier is coupled to a distributor body for conjoint rotation therewith, wherein an annular chamber formed in the distributor body is fluidically connected, via an oil pipe running in the axial direction, to a in a lubrication channel of a planetary gear pin that is fixed in the planet carrier. In order to compensate for positional tolerances between the distributor body and the planet carrier, the oil pipe, which in particular is designed to be flexible, can be accommodated in its end-side receiving openings in an axially displaceable and/or tiltable manner.

There is a constant need for fluid to be transferred between components rotating relative to each other and for this to be done in a way that requires the least possible maintenance.

The object of the invention is to set out measures that allow low-maintenance fluid transfer between components rotating relative to each other. Preferably, the object of the invention is to set out measures that allow high efficiency of the fluid transfer with low losses due to leakage.

The object is achieved by a fluid transfer device having the features of Claim 1, a wind turbine gearbox having the features of Claim 13, a drive train having the features of Claim 14, and a data agglomerate having the features of Claim 15. Preferred embodiments, which may in each case individually or in combination represent an aspect of the invention, are specified in the dependent claims and in the following description, with the scope of protection being defined by the claims. If a feature is presented in combination with another feature, this serves only for simplified presentation of the invention and is in no way intended to mean that said feature cannot also be a refinement of the invention without the other feature.

One aspect of the invention relates to a fluid transfer device for transferring a lubricant, in particular within a wind turbine gearbox for an industrial wind turbine, comprising a first component, a second component, which is rotatable relative to the first component, an annular chamber, which is formed on an end face of the first component facing the second component and serves to receive the lubricant, at least one hollow pin connected to the second component and extending axially into the annular chamber for fluidic communication between the annular chamber and a fluid channel of the second component, and a cover connected to the first component in order to captively retain the hollow pin in the annular chamber, wherein the cover forms a first plain bearing surface and the hollow pin is axially supported on the first plain bearing surface via a second plain bearing surface.

Since the transfer of the lubricant between the components rotating relative to each other takes place in the axial direction and not in the radial direction, it is easily possible to provide the fluid transfer of the lubricant on a particularly large diameter. In particular, if the fluid transfer device is to be used in a wind turbine gearbox for an industrial wind turbine, it is easier to make the wind turbine gearbox particularly large and to dimension it for particularly large power ranges, as may occur, for example, in offshore wind turbines at high wind speeds. With a fluid transfer device of this kind, a scale-up of the wind turbine gearbox to ever larger power classes is thus simplified or even made possible at all.

In the fluid transfer device, the annular chamber can be recessed in the first component. With reference to the end face of the first component facing the second component, the annular chamber can be formed completely in a from the end face in an axial region of the first component facing away from the second component. The annular chamber can, for example, have a substantially U-shaped cross section, which is formed substantially constant in particular in the circumferential direction, and is formed open towards the second component in the plane of the end face of the first component. A fluid line provided in or on the first component can open into the annular chamber in order to supply and/or remove lubricant. Since the hollow pin connected to the second component, in particular by screwing, protrudes into the annular chamber, a mouth opening of the hollow pin to the end face of the first component can be positioned axially offset into the first component. The mouth opening of the hollow pin can be positioned in a recessed manner in the annular channel. The fluid transfer of the lubricant between the annular channel and the hollow pin, moved relatively in the circumferential direction, can thus take place within the first component and does not have to be provided in an intermediate space between the first component and the second component. This saves installation space. In addition, the fluid transfer of the lubricant between the annular channel and the hollow pin can be spaced markedly apart from separating surfaces to be sealed between the components rotatable relative to each other, whereby it is much easier to achieve a reliable and long-lasting seal between the first component and the second component. In particular, the seal between the two components rotating relative to each other can be moved into the interior of the annular channel, which can reduce required axial installation space.

After the hollow pin protruding into the annular chamber has been fitted, the cover can be fastened to the first component. For example, the hollow pin can have a collar which protrudes radially outwards with respect to the longitudinal axis of the hollow pin and which, after the cover has been fitted, could abut directly or indirectly on the cover. After the cover has been fitted, this ensures that the hollow pin is captively retained in the state when protruding into the annular chamber. The captive retention of the hollow pin in the annular chamber form-fittingly blocks the hollow pin from being axially pulled out of the annular chamber, so that the mouth opening of the hollow pin always remains extending in the annular chamber during the intended operation.

At the same time, in a radius region that covers a radius region occupied by the annular chamber, the cover can form the first plain bearing surface. The first sliding surface can thus both perform the function of forming an axial plain bearing together with the second plain bearing surface and also perform the function of delimiting a part of the annular chamber. This exploits the recognition that the extent of the first plain bearing surface in the radial direction can be easily adjusted so as to protrude beyond the radial extent of the annular chamber, so that it is particularly easy, with a generous and/or large-dimension annular chamber, to form a first plain bearing surface that is as large as possible, and this at the same time leads to a good sealing effect within the axial plain bearing formed by the first plain bearing surface and the second plain bearing surface and to small pressure losses occasioned by flow losses within the fluid transfer device. The degree of viscous friction within the annular chamber can be reduced.

The second plain bearing surface, which is able to slide on the first plain bearing surface, can in principle be formed by the hollow pin, In particular by a collar protruding outwardly from the hollow pin, so that direct contact between the cover and the hollow pin can be provided in order to form the axial plain bearing. However, it is preferably also possible to exploit the axial extent of the hollow pin within the annular chamber by providing the axial support of the hollow pin on the first plain bearing surface of the cover only indirectly via a further component, so that an automatic alignment of the mutually adjacent plain bearing surfaces can also be effected in the event of an angular deviation and/or a radial offset of the hollow pin with respect to a main axis of rotation of the first and/or second component, and a good seal in the axial plain bearing can be ensured also in the case of installation tolerances. Leakage of lubricant, especially through the axial plain bearing, can thus be easily minimized.

By virtue of the hollow pin extending into the annular chamber and of the axially spaced seal on the first plain bearing surface, a good and long-lasting sealing of the annular chamber can be obtained even in the case of installation tolerances, so that a low-maintenance and/or low-leakage fluid transfer between components rotating relative to each other is possible.

The fluid transfer device can be used in principle for all lubricating arrangements in which a transfer between components turning relative to each other and/or rotating relative to each other is intended to take place in the axial direction. In particular, the fluid transfer device is provided where a fluid transfer of the lubricant can take place on a large radius and/or when insufficient installation space and/or insufficient accessibility is available in the vicinity of the main axis of rotation. The fluid transfer device is preferably suitable for pressure lubrication, in particular of bearing points and/or gearwheel meshes, in a wind turbine gearbox that is to be used for an industrial wind turbine.

Industrial wind turbines are designed primarily for generating energy from wind power, whereby electrical energy derived from the wind power can be fed in particular into a public power grid in order to be able to supply energy consumers with regenerative energy. A wind turbine gearbox designed for an industrial wind turbine is configured in particular for an output of more than 1.0 MW, preferably more than 5.0 MW and particularly preferably more than 7.5 MW, and is designed to be suitably robust and of large volume.

The lubricant that is to be transferred in the fluid transfer device is in particular a lubricating oil, although in principle other fluids, in particular liquids, suspensions or emulsions, can also be transferred using the fluid transfer device. In addition or alternatively, the lubricant can also perform a cooling function, so that lubricant can also be a coolant.

The first component and/or the second component can be designed as a rotating component, while the respective other component can be a stationary component or a component that is rotatable at a different speed. In any case, a relative speed between the first component and the second component can occur during the intended operation. The first and/or the second component can be, for example, part of a transmission, In particular a wind turbine gearbox, so that bearing points of the transmission can be lubricated with the aid of the fluid transfer device. Here, the first and/or the second component can be, for example, a planet carrier of a planetary gear. The respective other component can be, for example, part of another transmission stage or part of a fixed housing of the transmission.

The end face of the first component lies in particular in a radial plane perpendicular to a main axis of rotation of the first component and/or of the second component, which axis preferably coincides with a longitudinally extending center line of the first component and/or of the second component. Preferably, apart from the cover fastened to the first component, the end face forms an axial end of the first component, facing towards the second component, in a radius region occupied by the second component. The end face can in particular form a flange side of the first component, with the aid of which the cover can be flanged on to the first component.

The hollow pin can be formed to provide a fluidic connection between the first component and the second component via a cavity formed in the hollow pin. The hollow pin can at one end extend with its mouth opening into the annular chamber, and, at its other end, it can be fluidically connected to a fluid channel leading to a lubricating point. Alternatively, the hollow pin can also lead into an annular channel of the second component, wherein the annular channel can already be a part of the fluid channel. The hollow pin can for this purpose have an interior space formed in the manner of a hollow cylinder. Preferably, the hollow pin is also designed to be able to transfer forces occurring in the tangential direction without being sheared, so that the hollow pin can for example support torques applied by viscous friction, on the second component and/or on the first plain bearing surface of the cover. The hollow pin can be axially movable relative to the first component, although the kinematic reverse is also possible, in which the hollow pin is axially movable relative to the second component.

The cover can be designed in particular as a ring-shaped lid, wherein a plurality of cover segments following each other in the circumferential direction can also be provided. On the axial side facing the annular chamber, at least in the region of the first plain bearing surface, the cover can be provided with a plain bearing material, for example bronze, in particular by coating or additive manufacturing.

The first plain bearing surface and the second plain bearing surface can bear on each other, preferably pressed against each other, to form an axial plain bearing. The axial plain bearing formed in this way is designed in particular additionally for a sealing function, for example by the radial extent of the first plain bearing surface and of the second plain bearing surface being of greater dimension than would be required for supporting the expected axial forces. A leakage of lubricant on the axial plain bearing can thus be minimized and a maintenance interval, for example for topping-up of lubricant, can be significantly lengthened, as a result of which the fluid transfer device requires particularly low maintenance and/or wear can be minimized. In addition, by comparison with a gap seal, the axial plain bearing formed in this way can prevent particles or other contaminants from being able to penetrate into the annular chamber. Damage to a bearing point lubricated with the aid of the lubricant, in particular a plain bearing, caused by impurities being carried along can thus be avoided, as a result of which the fluid transfer device again requires particularly low maintenance.

In particular, the second plain bearing surface is formed by a support ring axially movable relative to the hollow pin, wherein the support ring is preferably coupled to the hollow pin via a spring element. Alternatively, the hollow pin can be connected to the support ring immovably and can be designed to be axially relatively movable within a fluid channel of the second component, wherein in particular the spring element is provided in the second component, preferably in the fluid channel. By its fastening to the second component, the hollow pin can be fixed in its axial relative position. For the functionality of the fluid transfer device, it is sufficient that the hollow pin extends into the annular chamber, wherein an axial offset and/or an angular offset of the hollow pin relative to the annular chamber can be allowed, without impacting the transfer of the lubricant between the annular chamber and the hollow pin. However, in order to form a sufficiently tight axial plain bearing, the hollow pin is not pressed directly against the first plain bearing surface of the cover; instead the hollow pin is supported indirectly on the cover via the support ring. The support ring can be pulled or pressed with the aid of the spring element onto the first plain bearing surface in order to be able to apply a sealing contact force between the first plain bearing surface of the cover and the second plain bearing surface formed by the support ring. In this case, the support ring can be supported on the hollow pin in particular via the spring element. The hollow pin can be guided relatively movably through the support ring in order to extend into the annular chamber. The support ring can be supported, via the spring element, on a part of the hollow pin extending into the annular chamber and can be pressed against the cover with a spring pretensioning of the spring element. An intermediate space of the cover can be closed with the aid of the support ring and sealed off from the cover. Part of an opening of the annular chamber, facing the second component, can be covered by the cover and another part can be covered by the support ring to a large extent, wherein the at least one hollow pin deliberately provides fluidic communication through the support ring. The support ring can thus make a contribution to the sealing of the annular chamber. If the internal pressure in the annular chamber increases, the lubricant within the annular chamber with the increased internal pressure can press against a rear side of the support ring facing away from the second component, as a result of which the contact force of the support ring on the cover increases, By means of the support ring pretensioned with the aid of the spring element and axially movable relative to the hollow pin, self-reinforcing sealing is achieved in the axial plain bearing formed by the first plain bearing surface of the cover and the second plain bearing surface of the support ring, whereby particularly low-loss fluid transfer is realized by virtue of the good sealing of the annular chamber.

The spring element can be designed in particular as a helical spring which, as a compression spring or tension spring, can preload the support ring relative to the hollow pin with a spring force, in order to be able to provide a sufficiently tight contact pressure between the first plain bearing surface of the cover and the second plain bearing surface of the support ring. For example, the spring element can be made of spring steel. In principle, however, it is also possible to produce the spring element from an elastomeric and/or rubber-elastic material and/or to design it as a compressible solid block. Alternatively, the contact force can be provided without using a spring, by a separate hydraulic pressure provided by means of a cylinder and/or by the weight force from the mass of the support ring.

Preferably, a receiving chamber encapsulated by the support ring and by the hollow pin is formed between the support ring and the hollow pin, wherein in particular the spring element is received at least to a large extent in the receiving chamber, wherein in particular the receiving chamber is sealed against the lubricant in the annular chamber. For example, the support ring can slide on the hollow pin during its axial relative movement. A fit provided between the support ring and the hollow pin can be chosen to be so narrow that the lubricant cannot pass the fit due to its rather high viscosity. In a preferred embodiment, a clearance is formed between the hollow pin and the support ring, in particular so that the support ring can align with the cover. This allows both the hollow pin and the support ring to remain movable to a pre-defined extent, allowing angular offsets to be easily compensated without affecting the sealing action of the axial plain bearing. In particular, a gap seal is formed between the support ring and the hollow pin. This allows a free space to be formed between the support ring and the hollow pin, thereby providing the receiving chamber for the spring element. If the spring element breaks, the fragments can be retained in the receiving chamber, so that the fragments cannot be flushed out with the lubricant and, together with the lubricant, reach places where the fragments may cause damage to components of the transmission.

Particularly preferably, the support ring has a through-opening for at least a part of the hollow pin, wherein at least one axially extending annular gap, preferably at least two annular gaps spaced axially apart from each other, is/are formed between the support ring and the hollow pin, wherein in particular the annular gap is dimensioned to allow an angular deviation Δα of the hollow pin, wherein in particular 0.01°≤Δα≤2.0°, preferably 0.02°≤Δα≤1.0°, and especially preferably 0.05°≤Δα≤0.5°. The support ring, preloaded with the spring element, can automatically align with the first plain bearing surface of the cover, so that the first plain bearing surface of the cover and the second plain bearing surface of the support ring lie flush with each other. In this case, the at least one annular gap between the support ring and the hollow pin can be dimensioned so large that a limited tilting of the hollow pin relative to the support ring can be permitted. Preferably, the annular gap is at the same time so small that, on account of the viscosity of the lubricant, in particular lubricating oil, the lubricant cannot pass the annular gap. By virtue of the suitably dimensioned lubrication gap, account can be taken of the fact that, due to installation tolerances, an angular deviation of the second component relative to the first component may occur, which continues in the relative position of the hollow pin to the first component, the cover and/or the support ring. It is thereby possible to avoid jamming and/or damage of the hollow pin within the through-opening.

In particular, the hollow pin is sealed on the support ring via a radially elastically deformable ring seal or membrane. Preferably, the ring seal is provided in at least one annular gap between the support ring and the hollow pin. If two or more annular gaps are provided, it is possible for the ring seal to be provided in all of the annular gaps or only in some of the annular gaps, in particular only in exactly one annular gap. The ring seal or the membrane can provide sufficient sealing of the annular channel to prevent leakage of lubricant between the support ring and the hollow pin through the through-opening of the support ring. The membrane can be designed to be able to accommodate the expected relative movements. This makes it possible to allow a particularly large angular deviation of the hollow pin relative to the support ring and to the first component without risk of leakage, since the ring seal, seen in the circumferential direction, can be easily compressed to different extents without losing its sealing effect.

Preferably, the support ring is composed of a plurality of support ring segments following each other in the circumferential direction, wherein in particular the support ring segments, on their tangential sides facing each other, form a sealing gap chicane, in particular a labyrinth seal. The respective support ring segment can in particular cover part of a circle. The segmented structure of the support ring simplifies the production of the support ring at lower manufacturing costs. At the connection points of the support ring segments, it is possible to provide a seal, for example in the form of a flat cover element. For example, the cover element can engage in a U-shape around a tangential joint between two support ring segments following each other in the circumferential direction, which results in a T-shaped join between the tangential joint of the support ring segments and the cover element, which provides an improved sealing effect compared to the tangential joint between the support ring segments. Preferably, a possible leakage path is deliberately extended by a non-level configuration of the tangential sides. A gap seal formed between the tangential sides by a remaining join can thus be improved in its sealing effect. The sealing gap chicane thus formed can perform the function of a labyrinth seal. Despite the segmented structure of the support ring, impairment of the sealing function is avoided or at least reduced.

Particularly preferably, the support ring is fastened to the second component and/or guided in translation via at least one fastening element, in particular a relief pin corresponding to the outer contour of the hollow pin, wherein in particular the relief pin allows axial relative mobility. In comparison to the hollow pin, the fastening element can be solid, i.e. not hollow, so that the fastening element, in comparison to the hollow pin, can support a higher load while having the same external dimensions. Preferably, the at least one hollow pin and the at least one fastening element, with substantially the same outer contour, are arranged uniformly distributed in the circumferential direction, preferably alternating. This means that it is not necessary to maintain a certain relative position in the circumferential direction when mounting the support ring, which simplifies the assembly.

In particular, the cover has an inner ring and an outer ring, wherein the hollow pin, in particular also the relief pin, is passed through an intermediate space between the inner ring and the outer ring, wherein in particular a passage area remaining in the intermediate space is closed by the support ring. The cover is thus of a multi-part design, in particular of a two-part design. The intermediate space between the inner ring and the outer ring of the cover allows a relative rotation of the hollow pin relative to the first component and to the cover connected to the first component. This prevents the hollow pin from striking against the cover. The intermediate space between the inner ring and the outer ring of the cover can be sealed in particular with the aid of the support ring. It is then not necessary to provide a radial bearing and/or a radial seal in the intermediate space. Instead, the preloaded support ring pressed onto the first plain bearing surface formed in part by the inner ring and by the outer ring can provide sealing of the intermediate space. The inner ring can provide a circumferentially closed first inner sliding surface and the outer ring can provide a coaxial and circumferentially closed first outer sliding surface radially offset with respect to the first inner sliding surface, which surfaces together form the first plain bearing surface of the cover. It is possible that the outer sliding surface and the inner sliding surface are arranged co-planar or axially offset. Correspondingly, the support ring can provide a circumferentially closed second inner sliding surface and a coaxial and circumferentially closed second outer sliding surface radially offset with respect to the second inner sliding surface, which surfaces together form the second plain bearing surface. The first plain bearing surface and the second plain bearing surface may be interrupted over the radial extent of the Intermediate space between the inner ring and the outer ring.

Preferably, the cover is fastened to the first component via a fastening means, wherein the fastening means, in particular a screw, is guided from an axial side facing away from the second component through an opening of the first component to the cover. For example, the cover has an internally threaded fastening opening. The cover can thus be easily fitted, since it is not necessary to provide a large axial Installation space between the first component and the second component. Instead, it is sufficient to position the cover or the inner ring and the outer ring using a tool acting in the radial direction, and to fasten, in particular screw, the cover from the rear side of the first component facing away from the second component. For this purpose, the first component can have suitable bores through which the fastening means can be brought to the cover that is to be fastened.

It is particularly preferably provided that the first plain bearing surface and/or the second plain bearing surface are/is positioned completely within the annular chamber reaching as far as the end face of the first component. The axial plain bearing formed by the first plain bearing surface and the second plain bearing surface can be arranged offset from the end face within the first component, in particular within a volume otherwise occupied by the annular chamber. This results in a compact and space-saving structure. In addition, the axial plain bearing is provided in a protected region where the first and/or second plain bearing surface cannot really be damaged during assembly.

In particular, the cover is centered on the annular chamber via a centering chamfer. For example, the cover protrudes slightly into the annular chamber with a centering nose that can slide on the centering chamfer, and/or a centering nose of the first component that can slide on the centering chamfer formed by the cover protrudes into the cover. This simplifies the fitting of the cover and prevents damage to the first and/or second plain bearing surface during assembly. Preferably, the first plain bearing surface begins at an end of the centering nose reaching axially into the annular chamber and extends radially from the centering nose.

Preferably, a seal is pressed between the cover and the end face of the first component. This can prevent leakage between the cover and the end face. Here, it is possible to take advantage of the fact that the cover can lie flat on the end face, so that it is particularly easy to seal a joint remaining between the cover and the end face.

Another aspect of the invention relates to a wind turbine gearbox for an industrial wind turbine, comprising a transmission stage, designed as a planetary transmission, and a fluid transfer device that can be designed and refined as described above, wherein in particular the second component of the fluid transfer device is formed by a planet carrier of the transmission stage and preferably the first component is formed by a fixed housing or a rotating gear component, in particular a further planet carrier, a further transmission stage following in the power flow direction. The wind turbine gearbox can be designed and refined in particular as explained above with reference to the fluid transfer device. By virtue of the hollow pin extending into the annular chamber and of the axially spaced seal on the first plain bearing surface, good and long-lasting sealing of the annular chamber can be obtained even in the case of installation tolerances, so that a low-maintenance and/or low-leakage fluid transfer between components of the wind turbine gearbox rotating relative to each other is possible.

Another aspect of the invention relates to a drive train for an industrial wind turbine, comprising a wind turbine gearbox that can be designed and refined as described above, for power transmission along a power flow from a wind-driven rotor to a generator, and a lubricating arrangement for lubricating bearing points and/or tooth meshes of the wind turbine gearbox, wherein in particular a flow direction of the lubricant transferred from the lubricating arrangement via the fluid transfer device is oriented counter to the power flow direction. The drive train can be designed and refined in particular as explained above with reference to the other aspects. By virtue of the hollow pin extending into the annular chamber and of the axially spaced seal on the first plain bearing surface, good and long-lasting sealing of the annular chamber can be obtained even in the case of installation tolerances, so that a low-maintenance and/or low-leakage fluid transfer between components of the drive train rotating relative to each other is possible.

Another aspect concerns a wind turbine for industrial generation of energy from wind power, with a stationary tower, a nacelle attached to a top end of the stationary tower, a wind-power-drivable rotor, an electric machine operable in generator mode, and a drive train received by the nacelle, which wind turbine can be designed and refined as described above, for torque-transmitted coupling of the rotor to the electric machine and conversion of a torque initiated by the rotor. The wind turbine can be designed and refined in particular as explained above with reference to the other aspects. By virtue of the hollow pin extending into the annular chamber and of the axially spaced seal on the first plain bearing surface, good and long-lasting sealing of the annular chamber can be obtained even in the case of installation tolerances, so that a low-maintenance and/or low-leakage fluid transfer between components of the wind turbine rotating relative to each other is possible.

Another aspect concerns an industrial application. The industrial application can have a drive means, which can be designed, for example, as an electric machine, internal combustion engine, hydraulic motor or wind-driven rotor. The drive means can be coupled to a gear for converting a torque and a speed of the power generated by the drive means, wherein the gear can be designed and refined analogously as explained above with reference to the wind turbine gearbox. In particular, the industrial application has a fluid transfer device, which can be designed and refined as described above. In turn, the gear of the industrial application can be coupled in a torque-transmitting manner to a mechanical application in which mechanical energy introduced via the gear can be utilized. The mechanical application includes, for example, a mill, vertical mill, sugar mill, cement mill, rock crusher, conveyor belt, pump, roller press, plate belt, pipe mill, rotary kiln, slewing gear, agitator, lifting device, garbage press, scrap press, shredder for recyclable materials made of waste or similar material, which may have been separated and/or sorted beforehand. The industrial application can be designed and refined in particular as explained above with reference to the other aspects. By virtue of the hollow pin extending into the annular chamber and of the axially spaced seal on the first plain bearing surface, good and long-lasting sealing of the annular chamber can be obtained even in the case of installation tolerances, so that a low-maintenance and/or low-leakage fluid transfer between components of the industrial application rotating relative to each other is possible.

One aspect further relates to a data agglomerate comprising data packets which are combined in a common file or distributed across different files and are intended for representing the three-dimensional design and/or the interactions of all constituent parts provided in the fluid transfer device, which can be formed and developed as described above, wherein the data packets are prepared, when they are processed by a data processing device for operating a machine tool for additive manufacturing of apparatuses, to additively produce the constituent parts of the fluid transfer device, in particular by 3D printing, and/or, when they are processed by a data processing device for carrying out a technical simulation, to carry out a simulation of the functioning of the fluid transfer device and output thus generated simulation results for further use, in particular in order to provide a verification of the fatigue strength as a function of variable loads and/or variable thermal loading, and if appropriate to compare them against measurement data determined on a device according to the invention that has been produced in reality and/or on a prototype of the device according to the invention. The data packets of the data agglomerate are specially adapted to the configuration according to the invention of the respective above-described device according to the invention, in order to be able to adequately represent the interaction according to the invention of the constituent parts of the device according to the invention during the processing in the data processing device. The data packets can in particular be stored in a spatially distributed manner, but can be adapted to one another in such a way that, in the case where all of the data packets are brought together in a common data processing device, the data agglomerate thus assembled provides all of the required data for additive manufacturing and/or a technical simulation with the aid of the data processing device for the device according to the invention. For example, the data packets are each separate parts of a data library, which are combined to form the data agglomerate and are adapted to one another in terms of their dimensions relative to one another and/or in terms of absolute dimensions and/or material properties corresponding to the respective device according to the invention. The data agglomerate can represent a virtual embodiment of the device in question according to the invention in the manner of what is referred to as a “digital twin”, which allows a virtual investigation in the form of a simulation or a real objectification by means of an additive manufacturing process. Such a digital twin is presented for example in US 2017/286572A1 , the disclosure contents of which are hereby referred to as being part of the invention.

When the data processing device of the machine tool processes the data agglomerate, the device according to the invention is produced such that, after the data agglomerate has been processed in the data processing device, the device according to the invention is obtained, at least in the form of a prototype. In particular, a data packet can in each case represent a separate constituent part of the respective associated device according to the invention, and therefore the individual constituent parts can be easily actually and/or virtually assembled in their relative position and/or relative movability in order to realize the interactions that are essential to the invention. In particular, it is possible, with the aid of the respective data packets, to generate the different constituent parts of the respective device separately and optionally from different materials by additive manufacturing and subsequently to assemble them to form a prototype of the device in question. The division of the data of the data agglomerate into different data packets thus makes possible, in straightforward fashion, a sequential additive manufacture of constituent parts, which are movable relative to one another, of the device in question in the form of a kit of parts, which is prepared so as to be assembled merely as expedient for the interaction, according to the invention, of the constituent parts of the prototype for solving the problem addressed by the invention.

Additionally or alternatively, it is possible, using the data packets of the data agglomerate, in a virtual environment during a technical simulation, to calculate and/or predict the individual constituent parts of the respective device and their interactions, the physical state and/or the change of physical parameters depending on different boundary conditions and/or over the time of the associated device according to the invention and to continue to use them for checking whether the device according to the invention is suitable enough for the Intended use on the basis of the hypothetical configuration and taking into account the hypothetical simulated influences. When the data agglomerate is processed by a data processing device representing the simulation environment, it is possible to be able to investigate the behavior of the device according to the invention, taking into account in particular changing boundary conditions. This makes it possible, for example, to investigate centrifugal force effects on individual constituent parts of the device according to the invention depending on different static and/or dynamic loads and/or different operating temperatures, with it being possible for such simulation results to be incorporated into the establishment of a fatigue strength verification. Preferably, the simulation results obtained after the data agglomerate has been processed in the data processing device for the simulation environment are stored in order to compare them against measurement data determined on a device according to the invention that has been produced in reality and/or on a prototype of the device according to the invention. This makes it possible to assess the quality of the simulation results obtained with the aid of the data agglomerate and/or, in particular in the case of particularly strong deviations, to identify measurement errors and/or an erroneous measurement. This simplifies and improves non-destructive quality control of the device according to the invention.

The data agglomerate enables cost-effective production of prototypes and/or computer-based simulations to study the functioning of the rotary body and/or of the holding tool, to identify problems in the specific use case and to find improvements. The solution to the problem addressed by the invention can be easily and cost-effectively checked using the data agglomerate.

Below, the invention will be explained by way of example with reference to the appended drawings on the basis of preferred exemplary embodiments, wherein the features presented below may in each case individually or in combination represent an aspect of the invention. It is shown in:

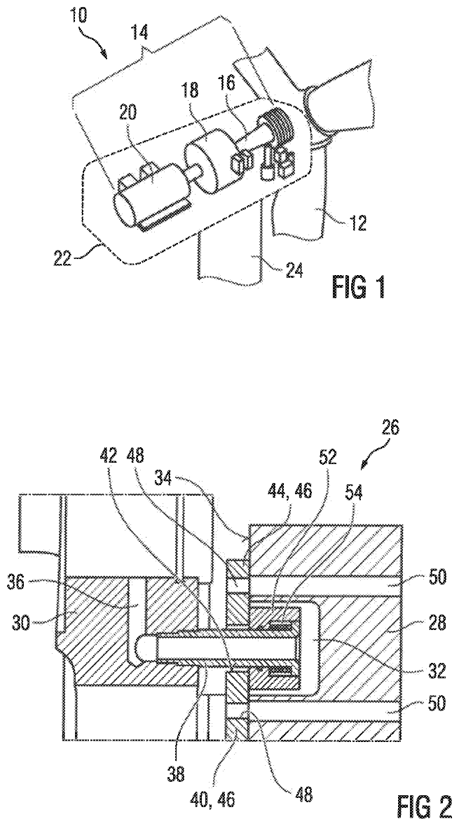

FIG. 1 a schematic perspective view of a wind turbine,

FIG. 2 a schematic cross-sectional view of a fluid transfer device for the wind turbine from FIG. 1,

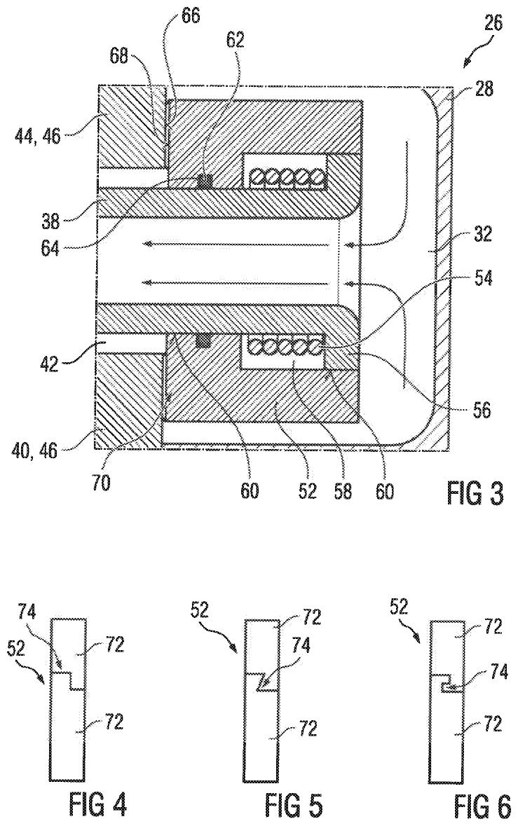

FIG. 3 a schematic detailed view of the fluid transfer device from FIG. 2,

FIG. 4 a schematic radial plan view of a first embodiment of a support ring of the fluid transfer device from FIG. 2,

FIG. 5 a schematic radial plan view of a second embodiment of a support ring of the fluid transfer device from FIG. 2,

FIG. 6 a schematic radial plan view of a third embodiment of a support ring of the fluid transfer device from FIG. 2,

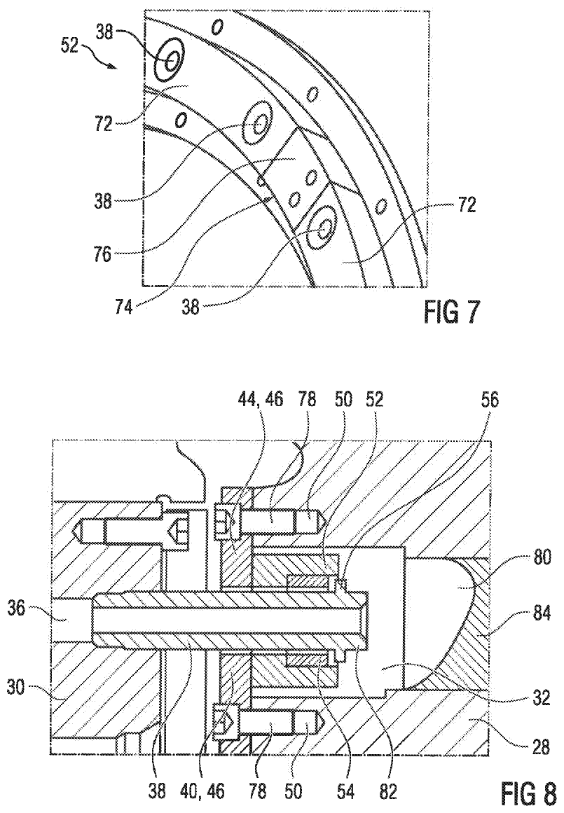

FIG. 7 a schematic perspective view of a further development of the embodiments of the support ring shown in FIG. 4 to FIG. 6, and

FIG. 8 a schematic detailed view of an alternative fluid transfer device for the wind turbine from FIG. 1.

The wind turbine 10 shown in FIG. 1 can be used for industrial generation of electrical energy from wind power. For this purpose, the wind turbine 10 has a rotor 12 which, wind-powered by wind, can be made to rotate. The rotor 12 is coupled to a drive train 14. For this purpose, the rotor 12 is connected to a rotor shaft 16, which is coupled within the drive train 14 to a transmission 18 in order to convert the torque introduced via the rotor 12 and the rotor shaft 16. The torque converted in the transmission 18 is supplied to an electric machine 20 which is operated in generator mode. The electrical energy generated by the electric machine 20 can be supplied to a rechargeable battery and/or to a power grid. In the illustrated exemplary embodiment, the drive train 14 is completely accommodated in a nacelle 22, which is attached to an upper free end of a stationary tower 24.

The fluid transfer device 26 shown in FIG. 2 can in particular be part of the transmission 18. However, it is also possible to use the fluid transfer device 26 for another transmission, an industrial application or some other device in which a fluid is to be transferred between components that are rotatable relative to each other. In the illustrated exemplary embodiment, the fluid transfer device 26 has a first component 28, which can be a fixed part of a housing of the transmission 18. A second component 30, which can be a planet carrier of a transmission stage of the transmission 18, can rotate relative to the first component 28. In the first component 28, an annular chamber 32 is formed which extends closed in the circumferential direction and which is substantially U-shaped in cross section and is open towards an end face 34 of the first component 28. By way of a fluid line (not shown), the annular chamber 32 can be supplied with a lubricant, in particular lubricating oil, which is to be transferred to a fluid channel 36 for lubrication and/or cooling on the second component 30, in particular on bearing points and/or tooth meshes.

A hollow pin 38, which communicates fluidically on the one hand with the fluid channel 36 of the second component 30 and on the other hand with the annular chamber 32 of the first component 28, is screwed onto the second component 30. For this purpose, the hollow pin 38 extends into the volume of the annular chamber 32. A cover 46 composed of an inner ring 40, and of an outer ring 44 spaced radially therefrom via an Intermediate space 42, can cover a part of the annular chamber 30. The cover 46, in particular both the inner ring 40 and the outer ring 44, has a fastening opening 48 with an internal thread into which a screw can be screwed through an associated bore 50 from a rear side of the first component 28, in order to screw the cover 46 to the first component 28. Alternatively, the bore 50 can be part of a protruding flange of the first component 28.

In particular, the cover 46 can captively retain the hollow pin 38 in the annular chamber 32 when said hollow pin has passed through the intermediate space 42. For this purpose, a support ring 52 is provided, which is supported on the hollow pin 38 and pretensioned via a spring element 54. As is shown in FIG. 3, the hollow pin, at its end extending into the annular chamber, has an outwardly protruding collar 56 on which the spring element 54 is supported or, for example, securely hooked. The support ring 52 can engage captively behind the collar 56 on the side facing the second component 30. In this case, a receiving chamber 58 for the spring element 54 can be left free between the collar 56 and the rearwardly engaging part of the support ring 52. The spring element 54 can be supported on the rearwardly engaging part of the support ring 52 or, for example, securely hooked onto same. In the axial direction outside the receiving chamber 58, an annular gap 60 can be formed between the hollow pin 38 and the support ring 52, the gap height and axial extent of which annular gap is in particular dimensioned in such a way that a predefined angular deviation of the hollow pin 38 relative to the first component 28, and indirectly also to the support ring 52, can be permitted, while preferably at least in one of the annular gaps 60 a leakage of lubricant into the receiving chamber 58 and/or out of the annular chamber 32 can be avoided. In particular, it is possible to provide in at least one of the annular gaps 60 an elastically deformable ring seal 62 which, in the illustrated exemplary embodiment, is inserted in a sealing groove 64 of the support ring 52.

The support ring 52 can be pressed against the cover 46 by the spring force of the spring element 54, as a result of which the hollow pin 38 is indirectly supported on the cover 46 via the spring element 54 and the support ring 52. Both on the inner ring 40 and on the outer ring 44, the cover 46 has a first plain bearing surface 66, against which a corresponding second plain bearing surface 68 of the support ring 52 is pressed. The first plain bearing surface 66 and the pressed-on second plain bearing surface 68 form an axial plain bearing 70, which on the one hand allows a sliding relative movement and on the other hand, in particular by conscious over-dimensioning of the plain bearing surfaces 66, 68, forms a fluid-tight seal for the lubricant. The sealing effect of the axial plain bearing 70 can be Influenced not only by the size of the surface contact, but also by the contact force of the support ring 52, wherein the contact force of the support ring 52 depends on the spring force and the spring characteristic curve of the spring element 54, but also on the internal pressure of the lubricant within the annular chamber 32. The sealing effect of the axial plain bearing 70 is thus dependent on the Inner pressure of the annular chamber 32 to be sealed and is therefore self-reinforcing.

A plurality of hollow pins 38 can be provided in a manner offset in the circumferential direction, preferably being arranged uniformly distributed in the circumferential direction. However, It is also possible to provide a fastening element which is offset with respect to the hollow pin 38 shown and in particular is designed as a relief pin, which preferably has substantially the same outer contour as the hollow pin 38, in order to Increase the stability and strength, as a result of which in particular it is possible to avoid the hollow pin 38 breaking off and/or shearing off under load.

The support ring 52 can be composed in particular of a plurality of support ring segments 72 following one another in the circumferential direction to form a circular ring. As is shown in FIG. 4, FIG. 5 and FIG. 6, a sealing gap chicane 74 can be formed between the tangential sides of the support ring segments 72 and can form a sufficient seal against leakage of the lubricant. Depending on the expected maximum internal pressure in the annular chamber 32 and/or the material properties of the lubricant, the sealing gap chicane 74 can be of greater or lesser complexity in order to be able to provide a sufficient sealing effect. Between the cover 46 and the end face 34 of the first component, a seal (not shown) may also be provided if the contact force and the surface contact of the cover 46 on the end face 34 is found to be not tight enough.

In the embodiment of the support ring 52 shown in FIG. 7, the sealing gap chicane 74 of the support ring 52, shown for example in FIG. 4, FIG. 5 or FIG. 6, is covered by a particularly substantially U-shaped cover element 76. The cover element 76 and the sealing gap chicane 74 to be covered are in particular offset in the circumferential direction with respect to the hollow pins 38 and/or relief pins. The sealing gap of the sealing gap chicane 74 can be extended by the cover element 76 and the sealing effect improved. In particular, the cover element 76 is fastened to a support ring segment 72 or to both support ring segments 72, thereby improving the stability of the support ring 52 composed of the plurality of support ring segments 72.

In the embodiment of the fluid transfer device 26 shown in FIG. 8, in comparison to the fluid transfer device 26 shown in FIG. 2, the bore 50 is not designed as a through-bore, but as an internally threaded blind hole open towards the second component 30. The cover 46 can be screwed to the bores 50 via screws 78, in particular ones at least partially recessed into the material. In order for the hollow pin 38 and/or the relief pin to be able to be screwed to the second component 28, the first component 28 can have a passage 80 which communicates with the annular chamber 32 and is provided in axial extension of the hollow pin 38 or of the relief pin, and through which a tool can be guided. The tool can be introduced through the passage 80 to a head contour 82, for example a hexagon, of the hollow pin 38 or of the relief pin adjacent to the collar 56, in order to screw the hollow pin 38 or the relief pin into place. After the screwing, the passage 80 can be closed and sealed off with a filling material 84, for example a plug or a potting compound.

1-15. (canceled)

16. A fluid transfer device for transferring a lubricant, in particular within a wind turbine gearbox for an industrial wind turbine, the fluid transfer device comprising:
a first component;
a second component rotatable relative to the first component;
an annular chamber formed on an end face of the first component facing the second component for receiving the lubricant;
at least one hollow pin connected to the second component and extending axially into the annular chamber for fluidic communication between the annular chamber and a fluid channel of the second component; and
a cover connected to the first component and designed to captively retain the hollow pin in the annular chamber, said cover forming a first plain bearing surface, with the hollow pin axially supported on the first plain bearing surface via a second plain bearing surface.

17. The fluid transfer device of claim 16, further comprising:
a support ring axially movable relative to the hollow pin and forming the second plain bearing surface; and
a spring element designed to couple the support ring to the hollow pin.

18. The fluid transfer device of claim 17, further comprising a receiving chamber encapsulated by the support ring and the hollow pin and formed between the support ring and the hollow pin, said spring element received at least to a large extent in the receiving chamber.

19. The fluid transfer device of claim 17, wherein the support ring includes a through-opening for at least a part of the hollow pin, wherein at least one axially extending annular gap, preferably at least two annular gaps spaced axially apart from each other, is/are formed between the support ring and the hollow pin, wherein in particular the annular gap is dimensioned to allow an angular deviation Δα of the hollow pin, wherein in particular 0.01°≤Δα≤2.0°, preferably 0.02°≤Δα≤1.0°, and especially preferably 0.05°≤Δα≤0.5°.

20. The fluid transfer device of claim 16, further comprising a radially elastically deformable ring seal or membrane designed to seal the hollow pin on the support ring.

21. The fluid transfer device of claim 17, wherein the support ring is comprised of a plurality of support ring segments following one another in a circumferential direction, said support ring segments forming a sealing gap chicane, in particular a labyrinth seal, on their tangential sides facing each other.

22. The fluid transfer device of claim 17, further comprising at least one fastening element, in particular a relief pin corresponding to an outer contour of the hollow pin, designed to fasten the second component and/or guiding the second component translatorily.

23. The fluid transfer device of claim 17, wherein the cover comprises an inner ring and an outer ring which define an intermediate space for passage of the hollow pin, said support ring designed to close in particular a passage area remaining in the intermediate space.

24. The fluid transfer device of claim 16, further comprising a fastener, in particular a screw, for fastening the cover to the first component, said fastener being guided from an axial side facing away from the second component through an opening of the first component to the cover.

25. The fluid transfer device of claim 16, wherein at least one of the first plain bearing surface and the second plain bearing surface is positioned completely within the annular chamber reaching as far as the end face of the first component.

26. The fluid transfer device of claim 16, wherein the cover is centered on the annular chamber via a centering chamfer.

27. The fluid transfer device of claim 16, further comprising a seal pressed between the cover and the end face of the first component.

28. A wind turbine gearbox for an industrial wind turbine, the wind turbine gearbox comprising:
a transmission stage designed as a planetary transmission and comprising a planet carrier; and
the fluid transfer device of claim 16, wherein the second component of the fluid transfer device is formed by the planet carrier of the transmission stage and the first component is formed by a fixed housing or a rotating gear component, in particular a further planet carrier, a further transmission stage following in a power flow direction.

29. A drive train for an industrial wind turbine, the drive train comprising:
a wind turbine gearbox for power transmission along a power flow from a wind-driven rotor of the wind turbine to a generator, said wind turbine gearbox comprising a transmission stage which is designed as a planetary transmission and comprises a planet carrier, and the fluid transfer device of claim 16, wherein the second component of the fluid transfer device is formed by the planet carrier of the transmission stage and the first component is formed by a fixed housing or a rotating gear component, in particular a further planet carrier, a further transmission stage following in a power flow direction; and
a lubricating arrangement designed to lubricate bearing points and/or tooth meshes of the wind turbine gearbox,
wherein a flow direction of lubricant transferred from the lubricating arrangement via the fluid transfer device is oriented counter to the power flow direction.

30. A data agglomerate, comprising data packets combined in a common file or distributed across different files for depicting a three-dimensional formation and/or interactions of all constituent parts provided in the fluid transfer device of claim 16, said data packets being prepared so as to carry out during processing by a data processing device for operating a machine tool for additive manufacturing of devices, to additively manufacture the constituent parts of the fluid transfer device, in particular by 3D printing, and/or to carry out during processing by a data processing device for a technical simulation a simulation of a functioning of the fluid transfer device and to output thus generated simulation results for further use, in particular in order to provide a verification of a fatigue strength as a function of variable loads and/or variable thermal loading.
